(19) United States
(12) Patent Application Publication
(10) Pub. No.: US 2020/0055746 A1
(43) Pub. Date: Feb. 20, 2020

(54) WASTEWATER EVAPORATION, TREATMENT OR RECOVERY SYSTEM

(71) Applicants: Norman Birmingham, Columbia, MD (US); John Verno, Morgantown, WV (US)

(72) Inventors: Norman Birmingham, Columbia, MD (US); John Verno, Morgantown, WV (US)

(21) Appl. No.: 15/992,821

(22) Filed: Aug. 16, 2018

(51) Int. Cl. C02F 1/04; C02F 1/16; C02F 1/44; C02F 1/52; B01D 1/00; B01D 5/00; B01D 9/00; F02C 6/18

(52) U.S. Cl. CPC C02F 1/048; C02F 1/16; C02F 1/44; C02F 1/52; B01D 1/0058; C02F 2101/12; B01D 5/0072; B01D 9/0059; F02C 6/18; C02F 2001/5218; B01D 5/006

(57) ABSTRACT

A method for treating waste water from various sources, removing solids and pollutants and then either evaporating or recycling the treated water. Waste water is received at the treatment site where the solids are removed before entering the system for treatment. The treatment consists of injecting the pressurized waste water into the exhaust stream of a turbine which is at least 900 degrees Fahrenheit, capturing it in pipes to keep it at above 600 degrees Fahrenheit for at sufficient time, temperature and turbulence to dispose of any volatile organic compounds. The system continues to either immediate atmospheric venting of the remaining treated water or in collecting ponds or tanks for evaporation. If the water is to be recovered it is cooled, condensed and sparged to release exhaust gases and the exhausted and condensed water is recovered.

### BACKGROUND OF THE INVENTION

### Field of the Invention

This disclosure is related to a system that uses a turbine unit to create electrical power, dispose/reclaim water from hazardous wastewater after various methods of pretreatment, and either evaporate the wastewater or recover water from the system which was not evaporated. Also described is a method of creating electrical power, condensing recovered water and recovering solids.

### Description of Related Art

Various industries create substantial amounts of polluted wastewater. These occurrences require solutions for the treatment of polluted wastewater from fossil fuel extractions, mines, co-gen and power plants, municipal water treatment and many other industrial applications.

Any reasonable opportunity to recover water or dispose of it without further harm to the planet or its environment is in immediate demand. Cost and environmentally effective treatment methods are needed to meet the demand. The effective disposal or recovery and treatment of this wastewater is critical to all industries, our planet and its environment.

### BRIEF SUMMARY OF THE INVENTION

Waste Water from various sources is received and filtered for contaminants of greater than 10 microns and may be further treated to remove other solids in suspension (can happen at both ends of the process) before proceeding to a storage tank for further processing.

Water is pumped from the storage tank to a pressurization system and into the injector system that infuses the water into the exhaust stream of the turbine being used to generate power. This exhaust proceeds down an exhaust pipe that has internal and external components designed to retain heat of sufficient length to slow the exhaust and insure proper time, temperature and turbulence for the disposal of volatile organic compounds.
The exhausted gases and vapor are spun at the end of the exhaust pipe to move gases and other particulates to the outside of the exhaust plume to allow separation from the vapor. Exhaust gases are vented through a stack in the roof of the room designed to allow expansion of the exhaust and to cool the water vapor. The exhaust gases are vacuum exhausted through the a directional vent stack of heights required by environmental rules and local ordinances. The remaining vapor is vacuumed through the side walls to a crystallization unit designed to remove any remaining solids or chlorides. The remaining water is sent to a tank for use as potable to be distributed via pipe or truck to final use point.
Any solids remaining in the membrane lined cooling room are recovered for further treatment by third parties or sent to a landfill along with any remaining solids collected at the crystallizer or in the filtration stage at the receiving terminal are also recovered for the same purposes.
The power generated from the turbine is stepped up (if necessary) in voltage to be sent through a substation and in to the existing electrical grid for distribution.
A cooling area with air conditioners and pumps to cool the turbine room and cooling room, a fire suppression unit including a water storage tank, control room for the turbine, generator and other controllable equipment and collected solids storage are included. Additionally, building(s) with sufficient spare parts storage, an operations trailer, liquid fuel storage and pumps and all required water, fuel or solid waste area spill control/containment round out the complete system.

### BRIEF DESCRIPTION OF DRAWINGS

FIG. 1 is a system drawing of the exterior view of the complete wastewater treatment and recovery system described herein, and

FIG. 2 is a more detailed drawing of portions of the system described herein, and

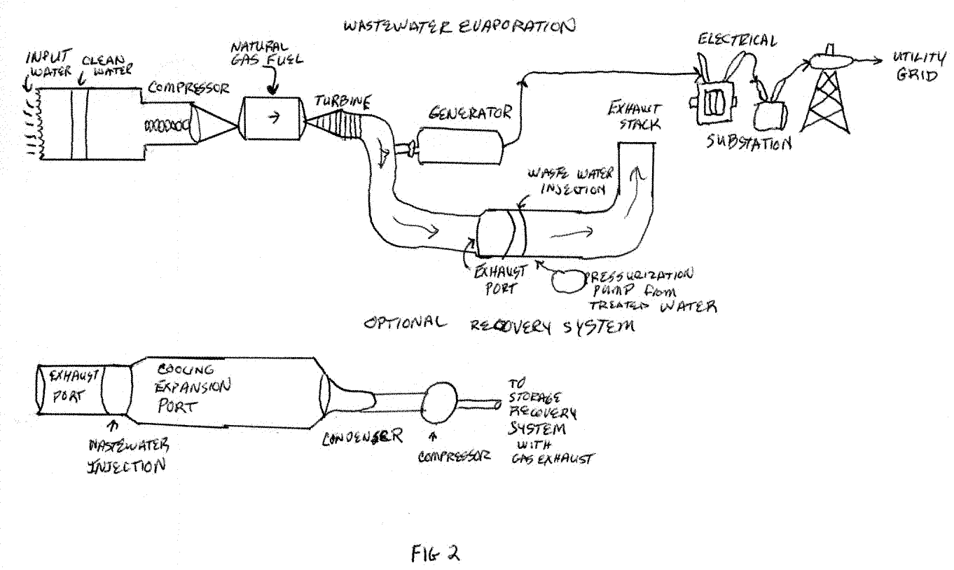

FIG. 3 is a series of drawings illustrating specific components of the system described herein.

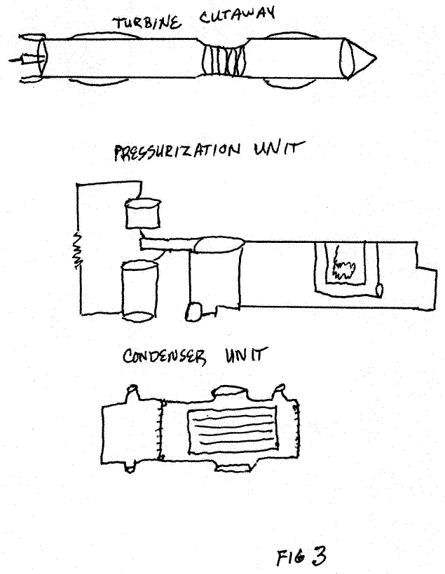

### DETAILED DESCRIPTION

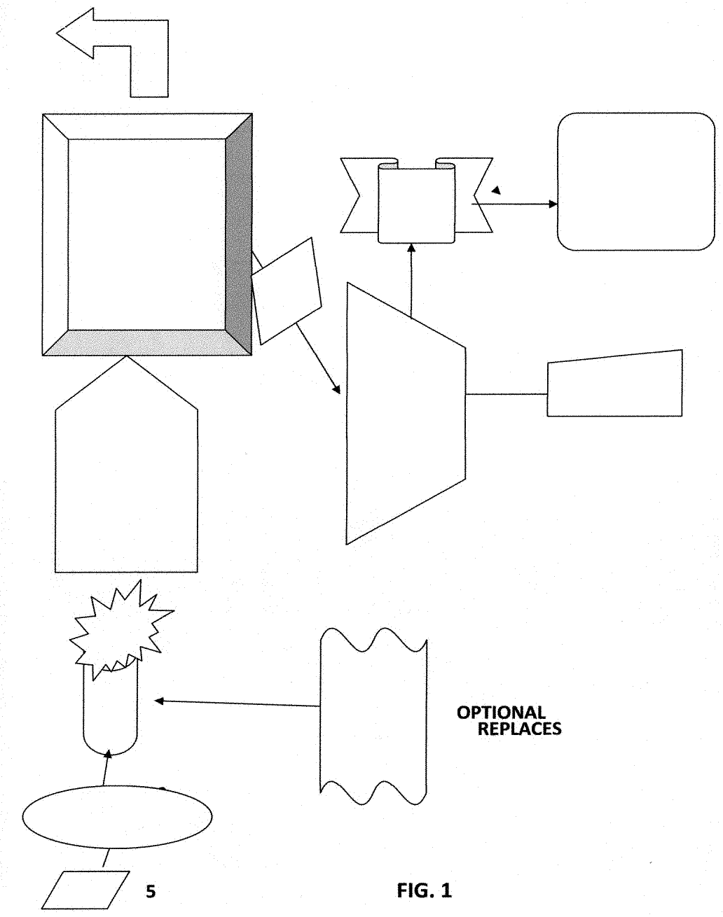

A non-limiting example of a system in this disclosure is shown in FIG. 1. With reference to FIG. 1, the system 1 includes a pretreatment system, turbine unit, a water pressurization mechanism, a wastewater containment unit storing wastewater after pretreatment, an enhanced exhaust system, an expansion chamber for water, gas and solid separation, controlled emission stack, solids drying and drainage area, a recovery unit, a treated water storage containment, a separated solids storage and caking mechanism, treated water condensation mechanism and an optional power generating turbine and system.

The wastewater received is pretreated in various fashions to remove certain suspended and dissolved solids. A fuel fired turbine unit creates a heated exhaust to which the pressurized pretreated wastewater is injected from the waste water containment unit. The wastewater is vaporized by the high speed superheated exhaust into the enhanced exhaust system to which contains certain engineering enhancements for various purposes. Certain required actions take place in the enhanced exhaust system during which the vaporized components are further modified to remove or alter their chemical signature and controlling other air pollutants while in transport to the expansion chamber. In the expansion chamber controlled exhaust flow is separated into its gas, liquid and solid components. The gas is in the controlled emissions stack along with treated water vapor if the no water recovery is required. The solids are recovered from the drying and drainage area. If water is to be recovered the exhaust stack has an added mechanism retarding the flow of water vapor and allowing only exhaust gases to be vented. A recovery unit, collects the water for pumping to either the condensation mechanism or in either case then to the treated water storage containment. The recovered semi-dried solids are recovered and sent to the caking mechanism after which the cakes are either sold or sent to a landfill. A power generating turbine system can replace the turbine unit with all other components of the system 1 remaining the same.

The turbine unit is selected based on the factors of exhaust temperature, exhaust port size and the level of pollutants exhausted from its liquid fueled combustion as specified by the system user to meet throughput and environmental requirements. If used, the same considerations are made for the power generating turbine system along with the type of fuel available and the power output required. All systems are readily available in the market. Additional components such as air conditioning may also be required to maintain the all component temperatures within the manufacturers specified tolerances.

A filtration process removes contaminants greater than 5 microns is utilized to remove suspended solids and with certain filter substances remove other suspended solids. The pumps and pressurization unit are sized to meet the throughput requirements of the application. The system limits are based on many factors with primary factor being the treatment necessary in the enhanced exhaust system. The water pressurization mechanism is scalable to meet the demand of the application with throughput ranges from 160 to 4,000 gallons per minute. The enhanced exhaust system is attached to the dispersal unit of the water pressurization mechanism and the turbine exhaust port where the exhaust stream mixes with dispersed water to form a treatable water vapor that is maintained at a proper residence time, temperature and turbulence to complete the required treatments before emptying into the expansion chamber.

Certain engineering enhancement to the enhanced exhaust system including flow dynamics to reduce or eliminate back pressure to the turbine, increase turbulence and reduce the speed of the exhaust to produce the required residence time.

The enhanced exhaust system shape, expansion size and length are determined by the treatment(s) that are required. The immediate expansion size is also dictated by the size of the dispersion pattern required.

The exhaust flow exits into the expansion chamber where the size and shape of the control mechanisms are dictated by any further requirements of the application. As an example, if the water vapor is to be exhausted the room is shaped to lead all the elements to the controlled emission stack and exhausting to the atmosphere via a speed controlled exhaust fan. The vapor is controlled by the speed of the fan and allowed to be in residence for a sufficient period to allow any potential pollutants, chlorides or other heavy materials to fall to the solids and drying and drainage area for collection and removal to the solids storage and caking mechanism where the solids are caked for final disposal.

In the event that treated water is be recovered a screen systems allowing water and solid separation is included at the floor level and further up the walls to remove water vapor or at the floor level in the recovery unit where any solids are contained and the water pumped to the treated water storage containment.

If water is to be further condensed from the vapor an exhaust fan directs the treated water to the treated water condensation mechanism. When the condensation is complete the water is pumped to the treated water storage containment.

In the event power generation is required, instead of using the turbine a power generating turbine is used with the remainder of the system used is as previously described. The power generating system can produce a minimum of 4 MW to 200 MW per day with water treatment throughput capacity rising from as little as 160 gallons to 2,200 gallons per minute.

Although various embodiments have been described in detail for the purpose of illustration, it is to be understood that such detail is solely for that purpose and that the disclosure is not limited to the disclosed embodiments, but, on the contrary, is intended to cover modifications and equivalent arrangements. For example, it is to be understood that this disclosure contemplates that, to the extent possible, one or more features of any embodiment can be combined with one or more features of any other embodiment.

The embodiment of the invention in which an exclusive property or privilege is claimed are defined as follows:

1. A method of creating electrical power, removing pollutants from various waste water, recycling a portion of the treated water to be potable and recovering solids comprising:
(a) electrical power is produced from commercially available power generation systems using liquid fueled turbines and attached generators with rated outputs ranging in scalability from 20 MW to 144 MW. Larger systems are available but may be cost prohibitive as part of the system. This system is controlled from a computer designed by its manufacturer and cooled to maintain an average temperature of 72 degrees Fahrenheit regardless of the size turbine used. The turbine enclosure is also temperature controlled using air conditioners to a maintain the specific temperature range indicated by the manufacturer for optimum output regardless of the outside ambient air temperature;

2. The method of claim 1, further comprising a system for infusing pressurized waste water from a filtered holding tanks or ponds into the exhaust stream of the turbine at rates ranging from 3 barrels per minute to 75 barrels per minute. The temperature of the exhaust stream ranges from 900 to 1,200 degrees Fahrenheit depending on the fuel and turbine used. The mounting of the exhaust pipe requires a composite material to attach the injectors and a coupling for the pipe attachment;
(a) the attachment of an exhaust pipe ranging from 14″ to 16′ in diameter depending on the size of the exhaust port of the turbine used;
(b) inclusion of materials inside and/or outside to cause the exhaust pipe to retain sufficient heat to remove volatile organic compounds and reduce hazardous air pollutants in the exhaust vapor stream. The pipe is sufficient in length to retain necessary heat, create required time in residence and turbulence to cause this effect. The scale of the exhaust pipe is from 50′ to 212′ depending on the scale of the turbines output and baffling included in the turbine exhaust plenum or exhaust pipe. The pipe exhaust pipe and its inclusions must keep the temperature of the exhaust at final exit at 650 degrees Fahrenheit. On certain turbines, the exhaust bypass adds additional capacity and can increase temperature while increasing waste water volume throughput;

3. The method of claims 1 and 2, further comprising a membrane lined cooling room for capturing water vapor, exhaust gases and any solids in the vapor solution, and exhausting excess vapor and turbine exhaust gases through a vent port in the roof controlled by vacuum controlled directional exhaust fans;
(a) the exhaust pipe also has an apparatus included to create a Venturi effect to spin solids, heavy metals to be collected from the vapor via filtration and drainage systems in the floor membrane that has additional filtration to remove other solids and chlorides for disposal or reuse. The capture system can be modified to include a system to deliver the water into an exhaust pipe running below the surface of a pond and add a pump to increase the pressure in the exhaust to sparge the water for evaporation while allowing the fine particles to precipitate downward to the receiving pond;
(b) vacuum systems (commercially available) in the walls at various heights remove vapor from the air and channel it to a commercially available crystallization unit (capable of treating up to 600,000 gallons per day of recovered water) to remove any additional chlorides or solids that may remain in the vapor. This treated water is sent to holding tank to be directed from there to its usable potable use;
(c) the solids from the crystallizer, recovered from the cooling room floor and any filtration that is necessary prior to inclusion in the pressurized waste stream is collected for further separation or disposal.
